(19) United States
(12) Patent Application Publication
(10) Pub. No.: US 2003/0046517 A1
(43) Pub. Date: Mar. 6, 2003

(54) Apparatus to facilitate multithreading in a computer processor pipeline

(76) Inventor: Gary R. Lauterbach, Los Altos Hills, CA (US)

Correspondence Address: PARK, VAUGHAN & FLEMING LLP, 508 SECOND STREET, SUITE 201, DAVIS, CA, 95616, US

(21) Appl. No.: 09/946,264

(22) Filed: Sep. 4, 2001

(51) Int. Cl. G06F 9/30

(52) U.S. Cl. 712/214; 712/235

(57) ABSTRACT

One embodiment of the present invention provides a system to facilitate multithreading a computer processor pipeline. The system includes a pipeline that is configured to accept instructions from multiple independent threads of operation, wherein each thread of operation is unrelated to the other threads of operation. This system also includes a control mechanism that is configured to control the pipeline. This control mechanism is statically scheduled to execute multiple threads in round-robin succession. This static scheduling eliminates the need for communication between stages of the pipeline.

### BACKGROUND

1. Field of the Invention

The present invention relates to pipelined processors in computer systems. More specifically, the present invention relates to an apparatus to facilitate multithreading in a computer processor pipeline.

2. Related Art

Modern processor designs are typically pipelined so that several computer instructions can be in progress simultaneously, thus increasing the processor's throughput. FIG. 1 illustrates a computer processor pipeline in accordance with the prior art. In the illustrated pipeline, there are four stages: fetch, decode, execution unit, and memory write. Hence, four different instructions can be in progress simultaneously with each instruction at a different stage in the pipeline. For example, a four stage pipeline can simultaneously process a memory write operation for a first instruction, an instruction execution for a second instruction, an instruction decode for the third instruction, and an instruction fetch for a fourth instruction.

The pipeline illustrated in FIG. 1 includes functional units associated with each of the pipeline stages, including instruction cache 102, decoder 104, register file 106, execution unit 108, and data cache 110. This pipeline operates under control of fetch control 112, and pipe control 114. Instruction cache 102 contains computer instructions related to at least one thread of execution. Fetch control 112 fetches the next instruction for the current thread from instruction cache 102. Next, fetch control 112 commands decoder 104 to decode the instruction being fetched from instruction cache 102. Decoder 104 decodes this instruction to determine source registers, destination register, operation to perform, and the like.

Register file 106 and execution unit 108 receives the output of decoder 104 and performs the operation under control of pipe control 114. Pipe control 114 then causes the output of execution unit 108 to be written into data cache 110.

Many current computer processor designs include a large number of resources such as arithmetic units, caches, busses, and the like that are under-utilized by many programs. In order to increase this utilization, engineers have proposed and implemented several techniques to multithread the pipeline hardware. These techniques include vertical multithreading and simultaneous multithreading.

In vertical multithreading, empty instruction issue cycles are used by another thread to execute an unrelated instruction stream. These empty instruction issue cycles are due to data dependencies, cache misses, and the like. In general, when the pipeline stalls, another thread of execution takes over the pipeline. In a recent implementation of vertical multithreading (see “A Multithreaded PowerPC™ Processor for Commercial Servers”, Borkenhagen, Eickenmeyer, Kalla, and Kunkel, IBM™ Journal of Research and Development, November, 2000), only empty cycles due to cache misses are assigned to an alternate thread. PowerPC is a trademark or registered trademark of Motorola, Inc. and IBM is a trademark or registered trademark of International Business Machines, Inc.

While vertical multithreading makes use of the pipeline to execute another thread while the first thread is stalled, this technique does not address any unused instruction issue cycles while the first thread is executing. In addition, vertical multithreading increases the complexity of the pipeline in order to allow the pipeline to offload a stalled thread and start another, independent thread.

Simultaneous multithreading makes use of unused issue slots in multiple issue super-scalar pipelines as well as the empty issue cycles addressed by vertical multithreading (see “Simultaneous Multithreading: Maximizing On-Chip Parallelism”, Tullsen, Eggers, and Levy, Proceeding of the 22^{nd} Annual International Symposium on Computer Architecture, June, 1995). In simultaneous multithreading, empty issue slots in a multiple issue pipeline are assigned to another independent thread. A major disadvantage of simultaneous multithreading is the complexity of the pipeline.

What is needed is an apparatus to facilitate multithreading in a computer processor pipeline that does not have the disadvantages listed above.

### SUMMARY

One embodiment of the present invention provides a system to facilitate multithreading a computer processor pipeline. The system includes a pipeline that is configured to accept instructions from multiple independent threads of operation, wherein each thread of operation is unrelated to the other threads of operation. This system also includes a control mechanism that is configured to control the pipeline. This control mechanism is statically scheduled to execute multiple threads in round-robin succession. This static scheduling eliminates the need for communication between stages of the pipeline.

In one embodiment of the present invention, a stage of the pipeline sequentially executes a first operation for each executing thread before executing a second operation for an executing thread.

In one embodiment of the present invention, a stage of the pipeline includes a substage for each executing thread and a single control mechanism. This single control mechanism controls the substage for each executing thread.

In one embodiment of the present invention, the pipeline includes an instruction fetch stage, an instruction decode stage, an execution stage, and a memory write stage.

One embodiment of the present invention provides a system to facilitate multithreading a computer processor pipeline. The system includes a pipeline stage and a control mechanism. The control mechanism is configured to control the pipeline stage. A logic element is inserted into the pipeline stage to separate the pipeline stage into a first substage and a second substage. The control mechanism controls the first substage and the second substage so that the first substage can process an operation from a first thread of execution and the second substage can simultaneously process a second operation from a second thread of execution.

In one embodiment of the present invention, the pipeline stage is separated into more than two substages so that the pipeline stage can process more than two threads of execution simultaneously.

In one embodiment of the present invention, the control mechanism is statically scheduled to execute multiple threads in round-robin succession. Static scheduling of the pipeline eliminates the need for communication between substages.

In one embodiment of the present invention, the control mechanism can control multiple substages of the pipeline stage simultaneously.

In one embodiment of the present invention, the pipeline stage includes, but is not limited to, an instruction fetch, an instruction decode, an operation execution, or a memory write.

### BRIEF DESCRIPTION OF THE FIGURES

FIG. 1 illustrates a computer processor pipeline in accordance with the prior art.

FIG. 2 illustrates a computer processor pipeline in accordance with an embodiment of the present invention.

FIG. 3 illustrates a stage of a computer processor pipeline in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

Processor Pipeline

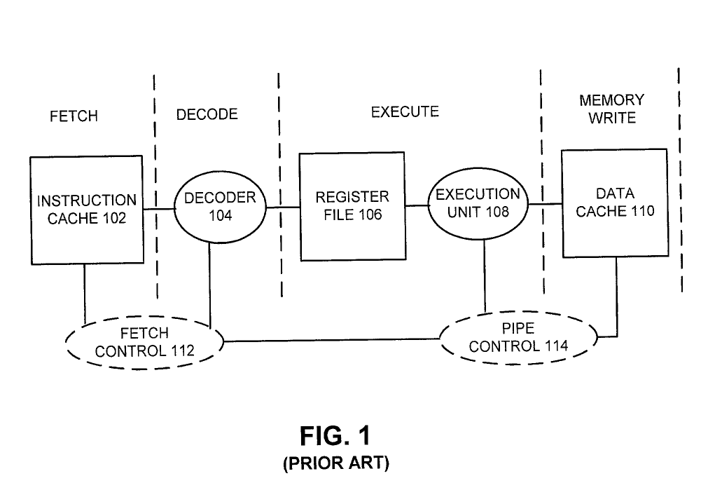

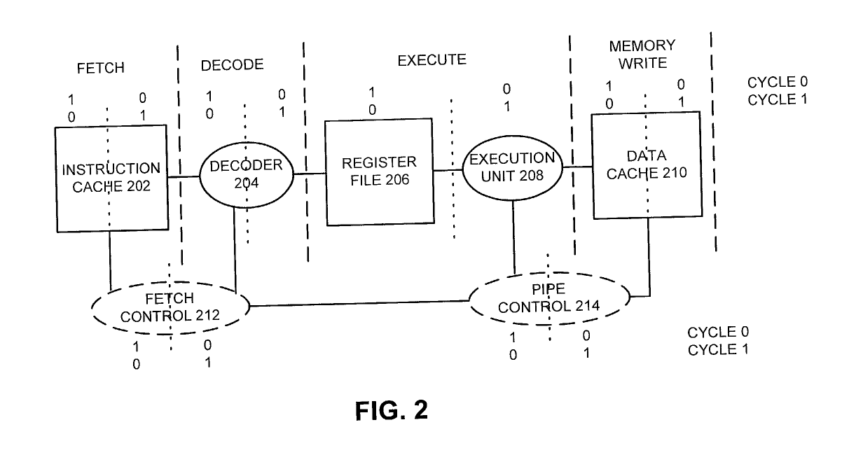

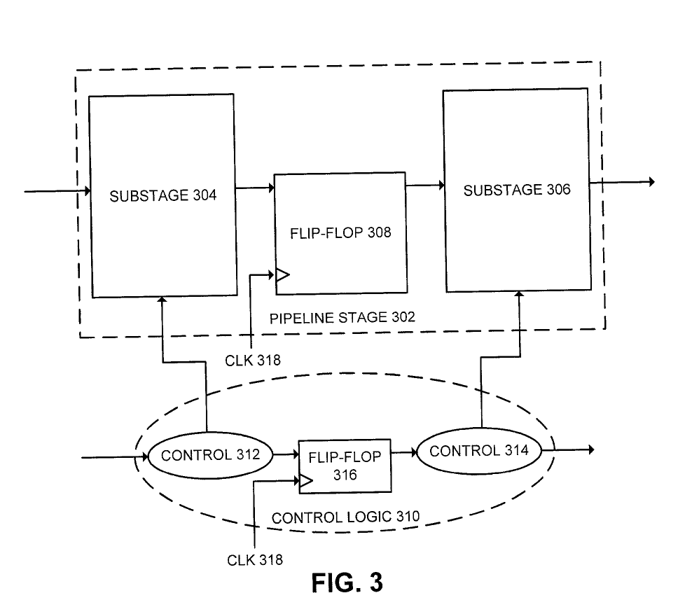

FIG. 2 illustrates a computer processor pipeline in accordance with an embodiment of the present invention. In this pipeline, as in the pipeline illustrated in FIG. 1, there are four stages: fetch, decode, execute, and memory write. However, this pipeline has eight different instructions—four instructions each from two different threads—in progress simultaneously with an instruction from each thread at each stage in the pipeline as described below. The pipeline in FIG. 2 is similar to the pipeline in FIG. 1, but differs in that each stage is divided into two substages as described below in conjunction with FIG. 3. The first substage processes an instruction for one thread while the second substage processes an instruction for a second thread. During the next clock cycle, the instruction, which was in the first substage moves to the second substage and the instruction, which was in the second substage moves to the first substage of the following stage.

This pipeline includes instruction cache 202, decoder 204, register file 206, execution unit 208, data cache 210, fetch control 212, and pipe control 214. Instruction cache 202, decoder 204, register file 206, execution unit 208, data cache 210, fetch control 212, and pipe control 214 are each logically divided into two parts. Instruction cache 202 can include computer instructions related to several threads of operation. Fetch control 212 fetches the next instruction for the current thread of operation from instruction cache 202. Note that these fetches alternate between the first thread and the second thread. Next, fetch control 212 signals decoder 204 to decode the instruction being fetched from instruction cache 202. Decoder 204 decodes this instruction to determine source registers, destination register, operation to perform, and the like.

Register file 206 and execution unit 208 receive the output of decoder 204 and, together, perform the operation under control of pipe control 214. Pipe control 214 then causes the output of execution unit 208 to be written into data cache 210.

During operation of the pipeline, each substage of the pipeline alternates between processing an instruction from the first thread and processing an instruction from the second thread. The process is executed such that an instruction passes through the pipeline in the same time as an instruction is passed through the pipeline in FIG. 1 above. However, more than one thread of execution is processed simultaneously.

A Pipeline Stage

FIG. 3 illustrates a stage of a computer processor pipeline in accordance with an embodiment of the present invention. Pipeline stage 302 and associated control logic 310 can include any stage of the pipeline. Pipeline stage 302 is divided into substages 304 and 306. Together, substages 304 and 306 include all of the logic required for pipeline stage 302.

Substages 304 and 306 are separated by flip-flop 308, which, in effect, divides pipeline stage 302 into two separate stages. Substage 302 can be processing an instruction from one thread while substage 304 is processing an instruction from a different thread. At the next cycle of clock 318, the instruction being processed by substage 306 is passed to the next stage, while the instruction being processed by substage 304 is passed to substage 306 to be completed. Note that a person of ordinary skill in the art can divide pipeline stage 302 into more than two substages by inserting more flip-flops in pipeline stage 302. As an extreme example, a twelve gate-level arithmetic-logic unit (ALU) stage could have twelve substages and be executing twelve threads simultaneously between the ALU' input and output.

Control logic 310 includes control 312 and control 314. Control 312 and control 314 are separated by flip-flop 316 in the same manner as substage 304 is separated from substage 306 by flip-flop 308. Flip-flop 316 passes the control signal from control 312 to control 314 on the next cycle of clock 318. Note that control logic 310 is divided into the same number of substages as pipeline stage 302.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. An apparatus to facilitate multithreading a computer processor pipeline, comprising:
a pipeline that is configured to accept instructions from multiple independent threads of operation, wherein each thread of operation is unrelated to other threads of operation; and
a control mechanism that is configured to control the pipeline, wherein the control mechanism is statically scheduled to execute multiple threads in round-robin succession, whereby static scheduling eliminates a need for communication between stages of the pipeline.

2. The apparatus of claim 1, wherein a stage of the pipeline sequentially executes a first operation for each executing thread before executing a second operation for an executing thread.

3. The apparatus of claim 1, wherein a stage of the pipeline includes a substage for each executing thread and a stage control mechanism, wherein the stage control mechanism controls the substage for each executing thread.

4. The apparatus of claim 1, wherein a stage of the pipeline includes one of an instruction fetch, an instruction decode, an operation execution, and a memory write.

5. A computer processor configured to use an apparatus that facilitates multithreading a pipeline, the apparatus comprising:
the pipeline that is configured to accept instructions from multiple independent threads of operation, wherein each thread of operation is unrelated to other threads of operation; and
a control mechanism that is configured to control the pipeline, wherein the control mechanism is statically scheduled to execute multiple threads in round-robin succession, whereby static scheduling eliminates a need for communication between stages of the pipeline.

6. The computer processor of claim 5, wherein a stage of the pipeline sequentially executes a first operation for each executing thread before executing a second operation for an executing thread.

7. The computer processor of claim 5, wherein a stage of the pipeline includes a substage for each executing thread and a stage control mechanism, wherein the stage control mechanism controls the substage for each executing thread.

8. The computer processor of claim 5, wherein a stage of the pipeline includes one of an instruction fetch, an instruction decode, an operation execution, and a memory write.

9. A computing system configured to use an apparatus that facilitates multithreading a pipeline, the apparatus comprising:
the pipeline that is configured to accept instructions from multiple independent threads of operation, wherein each thread of operation is unrelated to other threads of operation; and
a control mechanism that is configured to control the pipeline, wherein the control mechanism is statically scheduled to execute multiple threads in round-robin succession, whereby static scheduling eliminates a need for communication between stages of the pipeline.

10. The computing system of claim 9, wherein a stage of the pipeline sequentially executes a first operation for each executing thread before executing a second operation for an executing thread.

11. The computing system of claim 9, wherein a stage of the pipeline includes a substage for each executing thread and a stage control mechanism, wherein the stage control mechanism controls the substage for each executing thread.

12. The computing system of claim 9, wherein a stage of the pipeline includes one of an instruction fetch, an instruction decode, an operation execution, and a memory write.

13. An apparatus to facilitate multithreading a computer processor pipeline, comprising:
a pipeline stage;
a control mechanism, wherein the control mechanism is configured to control the pipeline stage; and
a logic element inserted into the pipeline stage, wherein the logic element separates a first substage of the pipeline stage from a second substage of the pipeline stage;
wherein the control mechanism controls the first substage and the second substage, whereby the first substage of the pipeline stage can process a first operation from a first thread of execution and the second substage can simultaneously process a second operation from a second thread of execution.

14. The apparatus of claim 13, wherein the pipeline stage is separated into more than two substages, wherein the pipeline stage can process more than two threads of execution simultaneously.

15. The apparatus of claim 14, wherein the control mechanism is statically scheduled to execute multiple threads in round-robin succession, whereby static scheduling eliminates a need for communication between substages.

16. The apparatus of claim 14, wherein the control mechanism can control multiple substages of the pipeline stage simultaneously.

17. The apparatus of claim 13, wherein the pipeline stage includes one of an instruction fetch, an instruction decode, an operation execution, and a memory write.

18. A computer processor configured to use an apparatus that facilitates multithreading a pipeline, the apparatus comprising:
a pipeline stage;
a control mechanism, wherein the control mechanism is configured to control the pipeline stage; and
a logic element inserted into the pipeline stage, wherein the logic element separates a first substage of the pipeline stage from a second substage of the pipeline stage;
wherein the control mechanism controls the first substage and the second substage, whereby the first substage of the pipeline stage can process a first operation from a first thread of execution and the second substage can simultaneously process a second operation from a second thread of execution.

19. The computer processor of claim 18, wherein the pipeline stage is separated into more than two substages, wherein the pipeline stage can process more than two threads of execution simultaneously.

20. The computer processor of claim 19, wherein the control mechanism is statically scheduled to execute multiple threads in round-robin succession, whereby static scheduling eliminates a need for communication between substages.

21. The computer processor of claim 19, wherein the control mechanism can control multiple substages of the pipeline stage simultaneously.

22. The computer processor of claim 18, wherein the pipeline stage includes one of an instruction fetch, an instruction decode, an operation execution, and a memory write.

23. A computing system configured to use an apparatus that facilitates multithreading a pipeline, the apparatus comprising:
a pipeline stage;
a control mechanism, wherein the control mechanism is configured to control the pipeline stage; and
a logic element inserted into the pipeline stage, wherein the logic element separates a first substage of the pipeline stage from a second substage of the pipeline stage;
wherein the control mechanism controls the first substage and the second substage, whereby the first substage of the pipeline stage can process a first operation from a first thread of execution and the second substage can simultaneously process a second operation from a second thread of execution.

24. The computing system of claim 23, wherein the pipeline stage is separated into more than two substages, wherein the pipeline stage can process more than two threads of execution simultaneously.

25. The computing system of claim 24, wherein the control mechanism is statically scheduled to execute multiple threads in round-robin succession, whereby static scheduling eliminates a need for communication between substages.

26. The computing system of claim 24, wherein the control mechanism can control multiple substages of the pipeline stage simultaneously.

27. The computing system of claim 23, wherein the pipeline stage includes one of an instruction fetch, an instruction decode, an operation execution, and a memory write.
